(19) United States
(12) Patent Application Publication
(10) Pub. No.: US 2006/0151927 A1
(43) Pub. Date: Jul. 13, 2006

(54) Failsafe buffer strut set

(76) Inventor: Kau Jong Jyr, Shin Chuang City (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(21) Appl. No.: 11/031,624

(22) Filed: Jan. 7, 2005

(51) Int. Cl. F16F 9/18

(52) U.S. Cl. 267/124

(57) ABSTRACT

A failsafe buffer strut set comprises an air/hydraulic cylinder and a link element. The link element comprises a rotation center. The air/hydraulic cylinder comprises a cylinder tube, a piston rod, a piston unit, an end bearing, an oil seal, an inner bearing, a piston-mounting element, and a cylinder-mounting element. The interior of the cylinder tube comprises an air/hydraulic damping chamber between the piston unit and the cylinder-mounting element, and a pressurizing chamber between the piston unit and the inner bearing. A proper volume of liquid and a compressed air are filled in the cylinder tube. The piston unit comprises a piston and a circuit groove on the surface thereof. The liquid and the compressed air flow between the air/hydraulic damping chamber and the pressurizing chamber through the circuit groove as a buffer when the air/hydraulic cylinder works. Due to the different densities and pressures of the liquid and the compressed air inside the cylinder tube, the air/hydraulic cylinder provides a well damping to bear weight.

### BACKGROUND OF THE INVENTION

1. Field of the Invention

The present invention relates to a failsafe buffer strut set, which particularly relates to an air/hydraulic cylinder sliding via an appropriate air/hydraulic pressure in the cylinder tube. Mounting with a link base, the present invention can be provided as a stable and smooth buffer supporter.

2. Description of the Related Art

Apparatus with cylinders, whether are air or hydraulic, has wide practical applications, like of body-builders, bedding, tools, or machines. For the wide usages, the safety and the structure of the cylinder are a significant subject.

The designs of cylinders in the prior arts, because of different utilization, comprise different functional devices. However, the cylinders in the prior arts comprise no buffer positional function or related device, and will soon extend or shorten to the end. That may cause damage or jury to users due to fail or mistake operation.

### SUMMARY OF THE INVENTION

The present invention relates to a failsafe buffer strut set combining advantages of hydraulic cylinders and air cylinders to an air/hydraulic cylinder. With proper volume of liquid and compressed air to a fine ratio of hydraulic pressure to air pressure, the air/hydraulic cylinder provides a slow buffer damping. Comprising a link element, this present invention offers a stable and smooth gradually bearing structure.

The failsafe buffer strut set of this present invention comprises an air/hydraulic cylinder and a link element, which the link element comprises a rotation center, and the air/hydraulic cylinder comprises a cylinder tube, a piston rod, a piston unit, an end bearing, an oil seal, an inner bearing, a piston-mounting element, a cylinder-mounting element an air/hydraulic damping chamber between the cylinder-mounting element and the piston unit, and a pressurizing chamber between the piston unit and the inner bearing, wherein the improvement comprises a circuit groove on the surface of a piston of the piston unit, and a proper volume of damping liquid and a compressed air inside the cylinder tube flowing between the air/hydraulic damping chamber and the pressurizing chamber through the circuit groove.

The flowing of the damping liquid and the compressed air balances the pressures between two sides of the piston inside the cylinder tube and become gentle and gradual buffer damping. Rotatable connecting with the link element, the air/hydraulic cylinder can bear proper weight, and smooth extend or shorten.

### BRIEF DESCRIPTION OF THE DRAWINGS

FIG. 1 is a diagram of the semi-sectional view of the present invention;

FIG. 2 is a diagram of the sectional view of the pulling-up action of the present invention;

FIG. 3 is a diagram of the sectional view of the pushing-down action of the present invention;

FIG. 4 is a diagram of the perspective view of one embodiment of the present invention.

FIG. 5 is a diagram of the embodimental application of bedding of the present invention.

FIG. 6 is a diagram of the embodimental application of toolbox of the present invention.

### DETAILED DESCRIPTION OF THE PREFERRED EMBODIMENTS

In the following description of the embodiments of the present invention and the mechanism of action thereof, please refer to the drawings.

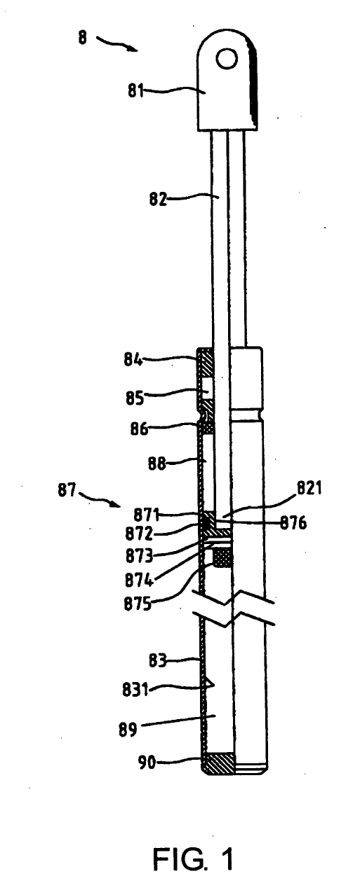

As shown in FIG. 1, the semi-sectional view of the present invention, an air/hydraulic cylinder 8 of the failsafe buffer strut set of the present invention comprises a cylinder tube 83 and a piston unit 87 set against on the inner surface 831 of the cylinder tube 83. The piston unit 87 is installed on the end of a piston rod 82, which is extending outward and set through against the central axial holes of an end bearing 84, an oil seal 85 and an inner bearing 86 of the cylinder tube 83 inside. The outward end of the piston rod 82 comprises or connects to a piston-mounting element 81. The air/hydraulic cylinder 8 comprises an air/hydraulic damping chamber 89 between the piston unit 87 and a seal cap 90 set at the end of the cylinder tube 83, and a pressurizing chamber 88 between the piston unit 87 and the inner bearing 86 of the cylinder tube 83 inside. The air/hydraulic damping chamber is filled with compressed air and oil in an appropriate ratio. The compressed air and oil damp the piston unit 87 compressing as buffer. As the bearing of the air/hydraulic cylinder 8 reducing or removing the piston rod 82 extends from the cylinder tube 83 to the original position due to the pressure of the oil and compressed air inside.

A piston 871, a washer 873, a special washer 874, are screwed in proper order at the piston end 821 of the piston rod 82 by a nut 875. The piston 871 comprises a circuit groove 876 on its surface, which further comprises an o-ring 872. The o-ring contacts against the surface 831 of the cylinder body 83.

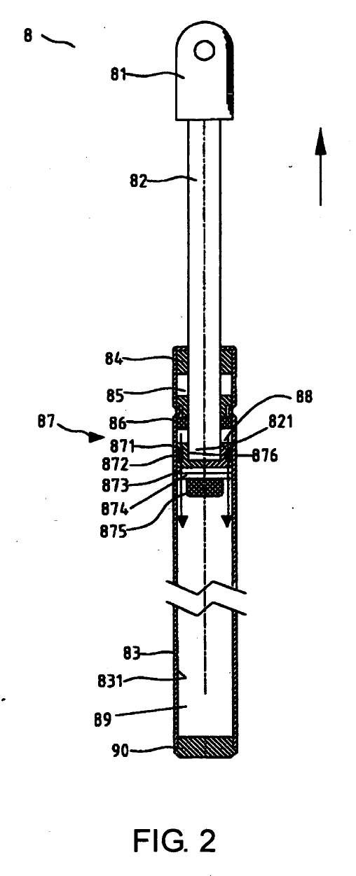

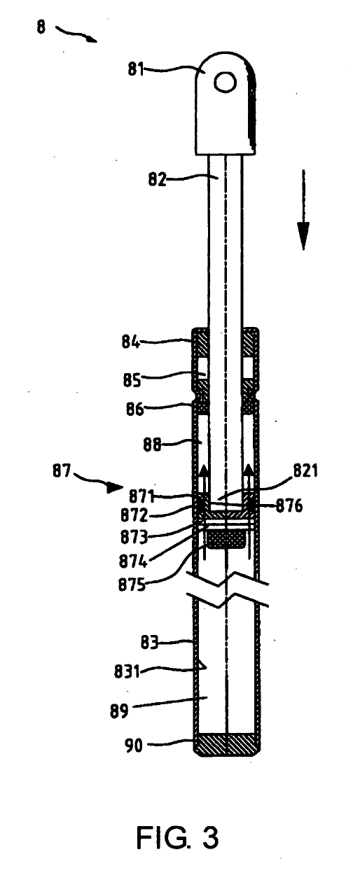

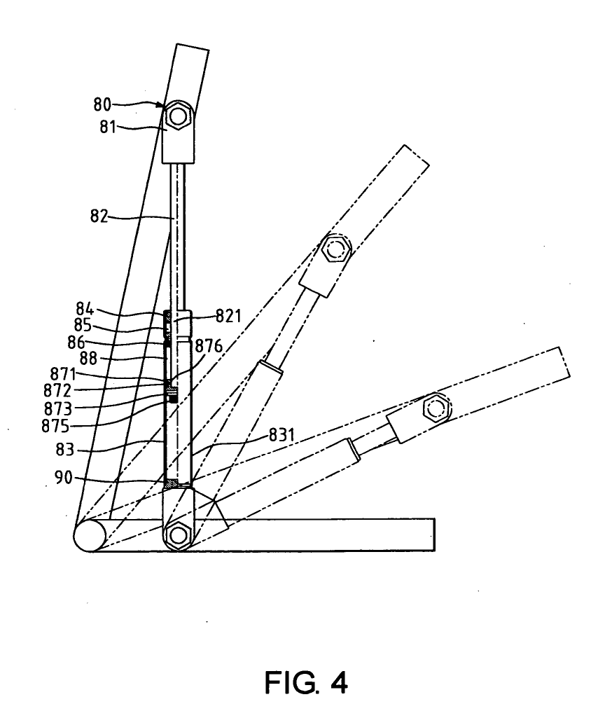

Please refer to the FIG. 4, a diagram of the perspective view of one embodiment of the present invention. The air/hydraulic cylinder 8 is mounted on a L-shape structure with two rotatable links to bear load. When the load is up, the air/hydraulic cylinder 8 is pulling extended. Please also refer to the FIG. 2. The compressed air and oil in the pressurizing chamber 88 flow into the air/hydraulic damping chamber 89 via the circuit groove 876 (indicated as the narrows inside the cylinder tube 83 in FIG. 2). The circuit groove 876 of the piston 871 comprises a proper clearance to control the flow rate of the compressed air and oil (the compressed air flows first because of an advance pressure ratio). As the compressed air and oil flowing into the air/hydraulic damping chamber 89 and the load raised following the air/hydraulic cylinder 8 rising little by little, the pressure inside the air/hydraulic damping chamber 89 increases to balance and to hold the load. When the load is closing down with a pushing action, please also referring to the FIG. 3, the effort of pushing action and the weight of the load press the piston 82 to compress the space of the air/hydraulic damping chamber 89. Because of the reaction of the compressed air and oil in the compressing air/hydraulic damping chamber 89, the compressed air and oil will flow through the circuit groove 876 into the damping chamber 89 (indicated as the arrows inside the cylinder in FIG. 3). The load will drop slower at a secure position when the pressures between the air/hydraulic damping chamber 89 and the pressurizing chamber 88 are balance and most compressed air is in the pressurizing chamber 88. Even though the weight of the load continuing presses the air/hydraulic cylinder 8, the load will drop slower till end due to that the oil flowing through the circuit groove 876 is much slower than the compressed air and the pressure in the air/hydraulic damping chamber 89 will also release slower.

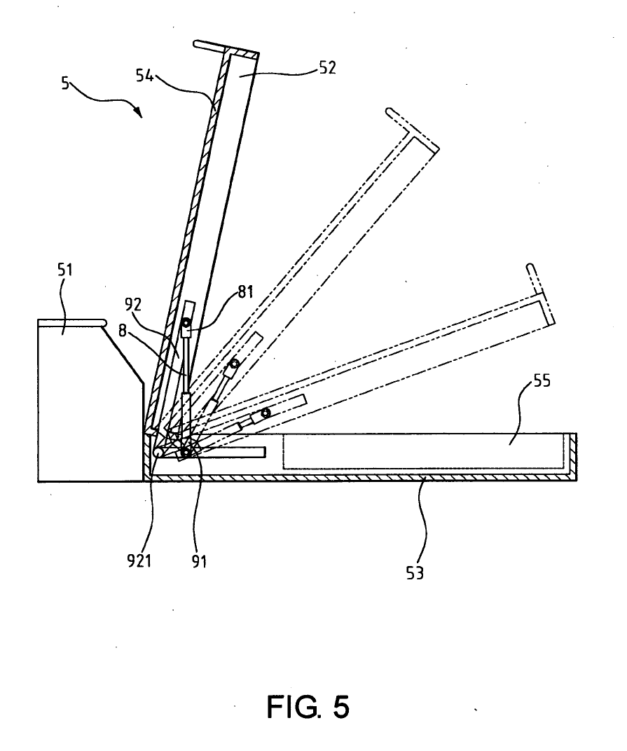

FIG. 5 is a diagram of the embodimental application of bedding of the present invention. Some designs of beds 5 comprise a storage space 55 under the bedplate 54. In the prior arts, normal air or oil cylinders are used to sustain the weight of the bedplate 54, so that the space under the bedplate 54 can be utilized. The bedplate 54 can be heavy and normal cylinders cannot properly bear the weight. In this embodiment of the present invention, an upper element 52 and a lower element 53 of the bed 5 comprise a link element 92 to connect each other, and the piston-mounting element 81 and a cylinder-mounting element 91 are fixed rotatable to the link element 92. When the bedplate 54 lifting, the air/hydraulic cylinder 8 extends and the upper element 52 raises till almost touches a bedhead cupboard 51. A rotation center 921 of the link element 92 rotates as the air/hydraulic cylinder 8 extends, and the storage space 55 inside the lower element 53 can be utilized. When the bedplate 54 closing, the air/hydraulic cylinder 8 retracts and the upper element 52 lowers till touches the lower element 53. The mechanism of the air/hydraulic cylinder 8 works as a proper buffer strut as the description above of FIG. 4.

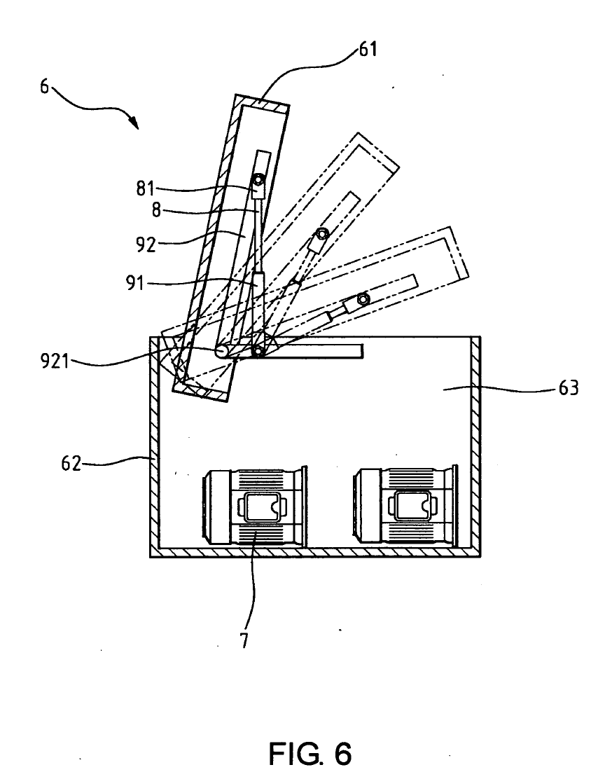

Referring to the FIG. 6, the diagram of the embodimental application of toolbox of the present invention, a large toolbox 6 comprises a heavy lid 61 and a box shell 62. The link element 92 connects the lid 61 and the box shell 62 inside, and the air/hydraulic cylinder 8 is mounted rotatable at the two ends thereof. As above description, the air/hydraulic cylinder 8 bears the weight of the lid 61 as a proper buffer strut and the heavy lid 61 is fall-safe, so that tools 7 can be easily storage in the storage space 63 inside the box 6.

Furthermore, the air/hydraulic cylinder 8 can be reverse mounted at the two ends of the link element 92 and works the same.

The foregoing describing of the preferred embodiment of the invention is for the purpose of illustration and description. It is not intended to exhaustive or to limit the invention to the precise from disclosed. Many other possible modifications and variations can be made without departing from the scope of the present invention, which following claims are depended.

What is claimed is:

1. A failsafe buffer strut set comprising an air/hydraulic cylinder and a link element, which the link element comprises a rotation center, and the air/hydraulic cylinder comprises a cylinder tube, a piston rod, a piston unit, an end bearing, an oil seal, an inner bearing, a piston-mounting element, a cylinder-mounting element, an air/hydraulic damping chamber between the cylinder-mounting element and the piston unit, and a pressurizing chamber between the piston unit and the inner bearing, wherein the improvement comprises:
a circuit groove on the surface of a piston of the piston unit;
a proper volume of damping liquid and a compressed air inside the cylinder tube flowing between the air/hydraulic damping chamber and the pressurizing chamber through the circuit groove.
